(19) United States
(12) Patent Application Publication
(10) Pub. No.: US 2004/0147280 A1
(43) Pub. Date: Jul. 29, 2004

(54) Mobile communication terminal and method of controlling the same as well as program to be executed for implementation of the method

(75) Inventor: Masaki Kamiya, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/626,402

(22) Filed: Jul. 24, 2003

(30) Foreign Application Priority Data
Jul. 24, 2002 (JP) 2002-214625

(51) Int. Cl. H04M 1/00; H04B 1/38

(52) U.S. Cl. 455/550.1; 455/566

(57) ABSTRACT

A communication terminal includes: a display unit; and a control unit configured to control the display unit in displaying, in a stand-by mode, at least one of: a first display mark which provides a reference information linked to past-referred data stored in the communication terminal; a second display mark which provides at least one executable function related to the past-referred data; a third display mark which provides an access-related information allowing the communication terminal to have an access to a past-referred file stored in a computer device connected to the communication network, and the access-related information being linked to the file; and a fourth display mark which provides at least one executable function related to the past-referred file.

### BACKGROUND OF THE INVENTION

1. Field of the Invention

The present invention relates to a mobile communication terminal, and a method of controlling the terminal as well as a program to be executed for implementing the control method, and more particularly to a mobile communication terminal having a display unit for displaying a display mark as an indicator of a command or object such as an icon.

All of patents, patent applications, patent publications, scientific articles and the like, which will hereinafter be cited or identified in the present application, will, hereby, be incorporated by references in their entirety in order to describe more fully the state of the art, to which the present invention pertains.

2. Description of the Related Art

A variety of mobile communication terminals are configured to allow user to have an access to an input interface for selecting one or more desired data from a variety of stored data including e-mails, image data, voice data and sound data, so as to refer selected one or more data through an output interface such as a display unit or a speaker unit.

In order to refer again the past-referred data, it is necessary to repeat the same operation as made for having referred the desired data firstly. For example, for referring again the past-referred data, it is necessary to start a function of referring the data through the input interface prior to selecting desired data from plural kinds of data listed or displayed on a display area. For example, in order to re-confirm the once-displayed email, it is necessary to start a mail-function and select a target mail from a mail list displayed on the display area. If, however, user could not remember the once-referred data even he or she intends to refer again the once-referred data, then it is difficult to retrieve the intended data.

In the above circumstances, the development of a novel mobile communication terminal free from the above problems is desirable.

### SUMMARY OF THE INVENTION

Accordingly, it is an object of the present invention to provide a novel mobile communication terminal free from the above problems.

It is a still further object of the present invention to provide a novel method of controlling a mobile communication terminal free from the above problems.

It is yet a further object of the present invention to provide a novel program to be executed for implementing a method of controlling a mobile communication terminal free from the above problems.

The present invention provides a communication terminal, a method of controlling the communication terminal as well as a program to be executed for implementing the method, wherein the communication terminal includes: a display unit; and a control unit configured to control the display unit in displaying, in a stand-by mode, at least one of: a first display mark which provides a reference information linked to past-referred data stored in the communication terminal; a second display mark which provides at least one executable function related to the past-referred data; a third display mark which provides an access-related information allowing the communication terminal to have an access to a past-referred file stored in a computer device connected to the communication network, and the access-related information being linked to the file; and a fourth display mark which provides at least one executable function related to the past-referred file.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a block diagram illustrative of a configuration of a novel mobile communication terminal in a preferred embodiment in accordance with the present invention.

FIG. 2A is a flow chart illustrative of operations of referring data when the mobile communication terminal shown in FIG. 1 is placed in a normal operation mode.

FIG. 2B is a flow chart illustrative of operations of referring data when the mobile communication terminal shown in FIG. 1 is placed in a stand-by mode.

FIG. 3 is a view illustrative of one typical example of transition of display screen of the display unit over the sequential operations shown in FIGS. 2A and 2B.

FIG. 4 is a diagram illustrative of a configuration of a mobile communication system including a server, a communication network and a base station, to which the mobile communication terminal shown in FIG. 1 is accessible.

FIG. 5A is a flow chart illustrative of an operation of referring a file in the server by the mobile communication terminal placed in a communication mode in the mobile communication system shown in FIG. 4.

FIG. 5B is a flow chart illustrative of another operation of referring a file in the server by the mobile communication terminal placed in a stand-by mode.

FIG. 6 is a flow chart illustrative of modified operations of referring data when the mobile communication terminal shown in FIG. 1 is placed in a stand-by mode.

FIG. 7 is a view illustrative of one typical example of transition of the stand-by mode display screen of the display unit over the sequential operations shown in FIG. 6.

FIG. 8 is a flow chart illustrative of further modified operations of referring data when the mobile communication terminal shown in FIG. 1 is placed in a stand-by mode.

### DETAILED DESCRIPTION OF THE PREFERRED EMBODIMENTS

A first aspect of the present invention is a communication terminal accessible to a communication network. The communication terminal includes: a display unit; and a control unit configured to control the display unit in displaying, in a stand-by mode, at least one of: a first display mark which provides a reference information linked to past-referred data stored in the communication terminal; a second display mark which provides at least one executable function related to the past-referred data; a third display mark which provides an access-related information allowing the communication terminal to have an access to a past-referred file stored in a computer device connected to the communication network, and the access-related information being linked to the file; and a fourth display mark which provides at least one executable function related to the past-referred file.

It is also possible that the access-related information includes an address.

It is also possible that the computer device comprises a server computer.

It is also possible that the communication terminal comprises a mobile communication terminal.

It is also possible that the control unit controls the display unit to display the past-referred data upon selection of the first display mark.

It is also possible that the control unit controls the display unit to display a lest of the at least one executable function related to the past-referred data upon selection of the second display mark.

It is also possible that the control unit controls the communication terminal to have a re-access to the past-referred file in the computer device upon selection of the third display mark.

It is also possible that the control unit controls the display unit to display a lest of the at least one executable function related to the past-referred file upon selection of the fourth display mark.

It is also possible that if further data of the same kind as the past-referred data are referred after the past-referred data have been referred, then the control unit controls the display unit in displaying an additional first display mark which provides an additional reference information linked to the further data, instead of the first display mark.

It is also possible that if further data of a different kind from the past-referred data are referred after the past-referred data have been referred, then the control unit controls the display unit in displaying not only the first display mark which provides the reference information linked to the past-referred data, but also an additional first display mark which provides an additional reference information linked to the further data.

It is also possible that if a further file to the past-referred file is referred after the past-referred file has been referred, then the control unit controls the display unit in displaying an additional third display mark which provides an additional access-related information allowing the communication terminal to have an access to the further file, instead of the file.

A second aspect of the present invention is a method of controlling a communication terminal accessible to a communication network. The method includes: displaying, in a stand-by mode, at least one of: a first display mark which provides a reference information linked to past-referred data stored in the communication terminal; a second display mark which provides at least one executable function related to the past-referred data; a third display mark which provides an access-related information allowing the communication terminal to have an access to a past-referred file stored in a computer device connected to the communication network, and the access-related information being linked to the file; and a fourth display mark which provides at least one executable function related to the past-referred file.

It is also possible that the access-related information includes an address.

It is also possible that the computer device comprises a server computer.

It is also possible that the communication terminal comprises a mobile communication terminal.

It is also possible that the past-referred data are displayed upon selection of the first display mark.

It is also possible that a lest of the at least one executable function related to the past-referred data is displayed upon selection of the second display mark.

It is also possible that the communication terminal has a reaccess to the past-referred file in the computer device upon selection of the third display mark.

It is also possible that a lest of the at least one executable function related to the past-referred file is displayed upon selection of the fourth display mark.

It is also possible that if further data of the same kind as the past-referred data are referred after the past-referred data have been referred, then an additional first display mark which provides an additional reference information linked to the further data is displayed, instead of the first display mark.

It is also possible that if further data of a different kind from the past-referred data are referred after the past-referred data have been referred, then not only the first display mark which provides the reference information linked to the past-referred data, but also an additional first display mark which provides an additional reference information linked to the further data are displayed.

It is also possible that if a further file to the past-referred file is referred after the past-referred file has been referred, then an additional third display mark which provides an additional access-related information allowing the communication terminal to have an access to the further file is displayed, instead of the file.

A third aspect of the present invention is a program to be executed to implement a method of controlling a communication terminal accessible to a communication network. The program includes: displaying, in a stand-by mode, at least one of: a first display mark which provides a reference information linked to past-referred data stored in the communication terminal; a second display mark which provides at least one executable function related to the past-referred data; a third display mark which provides an access-related information allowing the communication terminal to have an access to a past-referred file stored in a computer device connected to the communication network, and the access-related information being linked to the file; and a fourth display mark which provides at least one executable function related to the past-referred file.

It is also possible that the access-related information includes an address.

It is also possible that the computer device comprises a server computer.

It is also possible that the communication terminal comprises a mobile communication terminal.

It is also possible that the past-referred data are displayed upon selection of the first display mark.

It is also possible that a lest of the at least one executable function related to the past-referred data is displayed upon selection of the second display mark.

It is also possible that the communication terminal has a reaccess to the past-referred file in the computer device upon selection of the third display mark.

It is also possible that a lest of the at least one executable function related to the past-referred file is displayed upon selection of the fourth display mark.

It is also possible that if further data of the same kind as the past-referred data are referred after the past-referred data have been referred, then an additional first display mark which provides an additional reference information linked to the further data is displayed, instead of the first display mark.

It is also possible that if further data of a different kind from the past-referred data are referred after the past-referred data have been referred, then not only the first display mark which provides the reference information linked to the past-referred data, but also an additional first display mark which provides an additional reference information linked to the further data are displayed.

It is also possible that if a further file to the past-referred file is referred after the past-referred file has been referred, then an additional third display mark which provides an additional access-related information allowing the communication terminal to have an access to the further file is displayed, instead of the file.

The following embodiments are typical examples for practicing the foregoing aspects of the present invention. Although the subject matters of the present invention have been described in details, the following additional descriptions in one or more typical preferred embodiments or examples will be made with reference to the drawings for making it easy to understand the typical modes for practicing the foregoing aspects of the present invention.

First Embodiment:

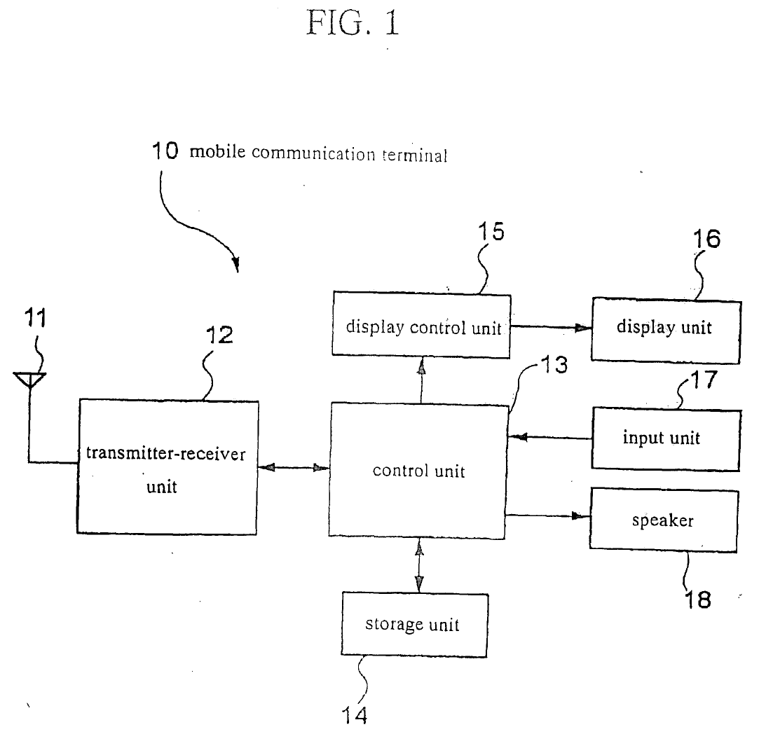

A first embodiment according to the present invention will be described in detail with reference to the drawings. FIG. 1 is a block diagram illustrative of a configuration Of a novel mobile communication terminal in a preferred embodiment in accordance with the present invention. A mobile communication terminal 10 may, for example, be realized by a mobile telephone. The mobile communication terminal 10 may include an antenna 11, a transmitter-receiver unit 12, a control unit 13, a storage unit 14, a display control unit 15, a display unit 16, an input unit 17 and a speaker 18.

The transmitter-receiver unit 12 performs a transmission and a receipt of signals through the antenna 11 under the control of the control unit 13. The control unit 13 controls respective parts of the mobile communication terminal 10 in accordance with an executed program which is stored in the storage unit 14. The storage unit 14 stores the program to be executed by the control unit 13, and also various kinds of data including e-mails, image data, voice data, sound data, telephone number lists, and URL addresses (uniform resource locator addresses). The storage unit 14 further stores a table which indicates correspondences between the kinds of data and icons.

The display control unit 15 controls the display unit 16 in displaying a variety of informations. The display unit 16 may be realized by, for example, a liquid crystal display. The input unit 17 provides an input interface which allows user to operate the mobile communication terminal The display unit 16 and the speaker 18 provide output interfaces to user.

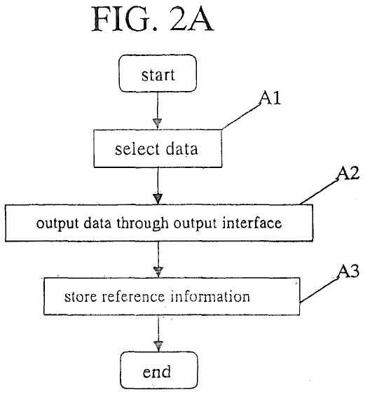

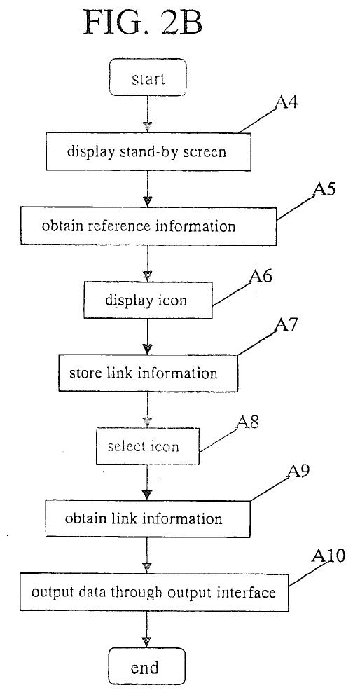

FIG. 2A is a flow chart illustrative of operations of referring data when the mobile communication terminal 10 shown in FIG. 1 is placed in a normal operation mode. FIG. 2B is a flow chart illustrative of operations of referring data when the mobile communication terminal 10 shown in FIG. 1 is placed in a stand-by mode. The stand-by picture is a display picture displayed when all of application software installed in the mobile communication terminal 10 are not executed, and the mobile communication terminal 10 is placed in an idling state. Normally, the stand-by picture includes a current time information and a battery information.

Operations of referring data when the mobile communication terminal 10 shown in FIG. 1 is placed in the normal operation mode will be described with reference to FIGS. 1 and 2A.

Operations of referring data stored in the mobile communication terminal 10 are as follows. In step A1, user operates the input unit 17 to select desired data stored in the storage unit 14. In step A2, the control unit 13 instructs the output interface to output the selected data to enable user to refer the data through the output interface, wherein the output interface includes the display unit 16 and the speaker 18. In step A3, in addition to the output of the data, the control unit 13 stores a reference information indicating the output data into a predetermined storage area of the storage unit 14, wherein the reference information includes the kind of output data, a management number allocated to the output data which is effective inside of the mobile communication terminal 10, and an address designating a storage area storing the output data in the storage unit 14. If other data have already been stored in this predetermined storage area in the storage unit 14, then the control unit 13 deletes the reference information of the other data from the predetermined storage area in the storage unit 14 before the control unit 13 stores the reference information of the output data in the predetermined storage area in the storage unit 14.

Operations of referring e-mail received by the mobile communication terminal 10 are as follows. In step A1, user operates the input unit 17 to start an e-mail referring function and select a desired e-mail stored in the storage unit 14. In step A2, the control unit 13 instructs the display control unit 15 to have the display unit 16 display the selected e-mail stored in the storage unit 14, to enable user to refer the e-mail through the display unit 16. In step A3, in addition to the output of the e-mail, the control unit 13 stores a reference information indicating the output e-mail data into a predetermined storage area of the storage unit 14, wherein the reference information includes the kind of output e-mail data, a management number allocated to the output e-mail data which is effective inside of the mobile communication terminal 10, and an address designating a storage area storing the output e-mail data in the storage unit 14. If other data have already been stored in this predetermined storage area in the storage unit 14, then the control unit 13 deletes the reference information of the other data from the predetermined storage area in the storage unit 14 before the control unit 13 stores the reference information of the output data in the predetermined storage area in the storage unit 14.

Operations of referring image received by the mobile communication terminal 10 are as follows. In step A1, user operates the input unit 17 to start an image referring function and select a desired image stored in the storage unit 14. In step A2, the control unit 13 instructs the display control unit 15 to have the display unit 16 display the selected image stored in the storage unit 14, to enable user to refer the image through the display unit 16. In step A3, in addition to the output of the image, the control unit 13 stores a reference information indicating the output image data into a predetermined storage area of the storage unit 14, wherein the reference information includes the kind of output image data, a management number allocated to the output image data which is effective inside of the mobile communication terminal 10, and an address designating a storage area storing the output image data in the storage unit 14. If other data have already been stored in this predetermined storage area in the storage unit 14, then the control unit 13 deletes the reference information of the other data from the predetermined storage area in the storage unit 14 before the control unit 13 stores the reference information of the output data in the predetermined storage area in the storage unit 14.

Operations of referring sound received by the mobile communication terminal 10 are as follows. In step A1, user operates the input unit 17 to start a sound referring function and select a desired sound stored in the storage unit 14. In step A2, the control unit 13 instructs the display control unit 15 to have the sparker 18 speak the selected sound stored in the storage unit 14, to enable user to refer the sound through the sparker 18. In step A3, in addition to the output of the sound, the control unit 13 stores a reference information indicating the output sound data into a predetermined storage area of the storage unit 14, wherein the reference information includes the kind of output sound data, a management number allocated to the output sound data which is effective inside of the mobile communication terminal 10, and an address designating a storage area storing the output sound data in the storage unit 14. If other data have already been stored in this predetermined storage area in the storage unit 14, then the control unit 13 deletes the reference information of the other data from the predetermined storage area in the storage unit 14 before the control unit 13 stores the reference information of the output data in the predetermined storage area in the storage unit 14.

Operations of referring telephone number received by the mobile communication terminal 10 are as follows. In step A1, user operates the input unit 17 to start a telephone number referring function and select a desired telephone number stored in the storage unit 14. In step A2, the control unit 13 instructs the display control unit 15 to have the display unit 16 display the selected telephone number stored in the storage unit 14, to enable user to refer the telephone number through the display unit 16. In step A3, in addition to the output of the telephone number, the control unit 13 stores a reference information indicating the output telephone number data into a predetermined storage area of the storage unit 14, wherein the reference information includes the kind of output telephone number data, a management number allocated to the output telephone number data which is effective inside of the mobile communication terminal 10, and an address designating a storage area storing the output telephone number data in the storage unit 14. If other data have already been stored in this predetermined storage area in the storage unit 14, then the control unit 13 deletes the reference information of the other data from the predetermined storage area in the storage unit 14 before the control unit 13 stores the reference information of the output data in the predetermined storage area in the storage unit 14.

If the kind of the output data is different from the kind of the other data having already been stored in this predetermined storage area in the storage unit 14, then it is possible to store the reference information of the output data into the storage unit 14 without deletion of the reference information of the other data. If, however, the kind of the output data is identical with the kind of the other data having already been stored in this predetermined storage area in the storage unit 14, then it is necessary to delete the reference information of the other data prior to storing the reference information of the output data. For example, if the first e-mail was referred before the second e-mail has been referred, then the reference information of the second e-mail only is stored in the storage unit 14. If the e-mail was referred before the image has been referred, then both the reference informations of the e-mail and image are stored in the storage unit 14.

Operations of referring data when the mobile communication terminal 10 is placed in a stand-by state will be described with reference to FIGS. 1 and 2B.

In step A4, the mobile communication terminal 10 is transitioned from the normal communication mode into the stand-by mode, whereby the display screen is transitioned to the stand-by screen or the stand-by picture. In step A5, the control unit 3 obtains the stored reference information from the storage unit 14. In step A6, the control unit 13 finds a corresponding icon to the kind of the data belonging to the obtained reference information with reference to a table stored in the storage unit 14, wherein the table includes correspondences between the reference informations and the kinds of data. The control unit 13 instructs the display control unit 15 to display the found icon, whereby the ion is displayed on the stand-by screen. The control unit 13 further links the displayed icon to the reference information designating the data, so that the control unit 13 stores this information of the link between the icon and the data or the reference information into a predetermined storage area of the storage unit 14 in step A7.

In step A8, if the icon displayed on the stand-by screen is selected by user through the input unit 17, then the control unit 13 obtains the link information from the storage unit 14 in step A9. The control unit 13 selects the data associated to the selected icon, based on the obtained link information and instructs the output interface to output the selected data in step A10, thereby allowing user to refer the data again even in the mobile communication terminal 10 is placed in the stand-by state.

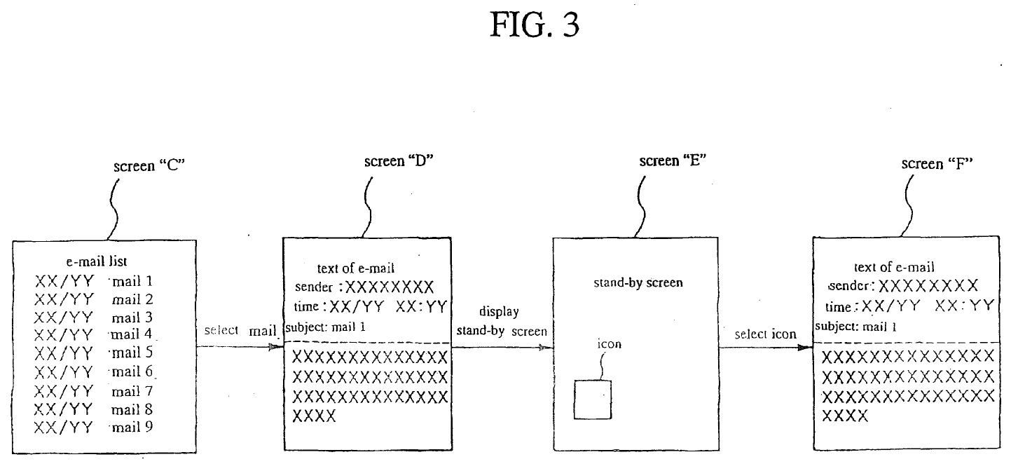

FIG. 3 is a view illustrative of one typical example of transition of display screen of the display unit 16 over the sequential operations shown in FIGS. 2A and 2B. The following descriptions will be made by taking an example that the e-mail is referred.

With reference to FIGS. 1 and 3, user operates the input unit 17 to start the e-mail reference function, whereby a list of e-mails stored in the storage unit 14 is displayed on the display unit 16 as shown by a screen “C”. User selects one e-mail “1” from the e-mail list through the input unit 17, whereby a text of this selected e-mail “1” is displayed on the display unit 16 as shown by a screen “D”.

After user completed to refer the text of the selected e-mail “1”, the display screen is transitioned to the stand-by screen, while an icon is displayed on the stand-by screen, wherein the displayed icon is associated with the e-mail “1” as shown by a screen “E”. Normally, the current time information and the battery information are also displayed on the stand-by screen, even illustrations thereof are omitted in the screen “E”. User may operates the input unit 17 to select the icon, so that the text of the e-mail “1” is again displayed on the display unit 16 as shown by a screen “F”.

The mobile communication terminal 10 may also be configured to be accessible through any communication networks to a server, so that the mobile communication terminal 10 allows user to refer a file stored in the server through the communication network.

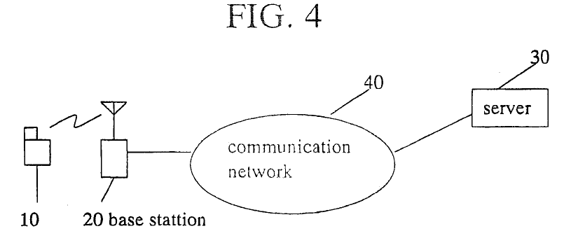

FIG. 4 is a diagram illustrative of a configuration of a mobile communication system including a server 30, a communication network 40 and a base station 20, to which the mobile communication terminal 10 shown in FIG. 1 is accessible.

The base station 20 is connected to the communication network 40. The base station 20 allows a wire-less commination to the mobile communication terminal 10. The server 30 is also connected to the communication network 40. The server 30 stores a plurality of files, for example, Hyper-Text Markup Language (HTML) files. The communication network 40 may be realized by a mobile telephone network or the Internet.

The mobile communication terminal 10 is accessible to each of the plural files in the server 30 through the base station 20 and the communication network 40.

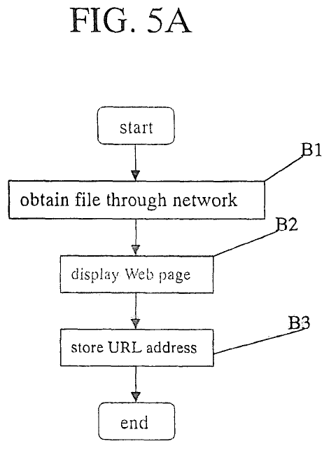

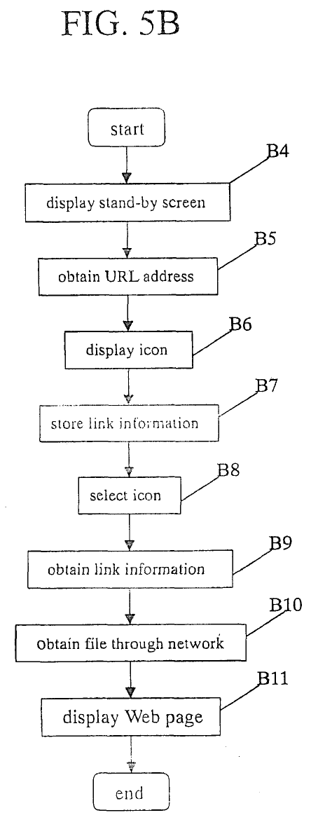

FIG. 5A is a flow chart illustrative of an operation of referring a file in the server 30 by the mobile communication terminal 10 placed in a communication mode in the mobile communication system shown in FIG. 4. FIG. 5B is a flow chart illustrative of another operation of referring a file in the server 30 by the mobile communication terminal 10 placed in a stand-by mode.

The operation of referring a file in the server 30 by the mobile communication terminal 10 placed in a communication mode in the mobile communication system will be described with reference to FIGS. 1, 4 and 5A. In step B1, user operates the input unit 17 of the mobile communication terminal 10 to start a browser function for having an access to the server 30 through the base station 20 and the communication network 40, so that the mobile communication terminal 10 obtains a desired file stored in the server 30. In step B2, the control unit 13 instructs the display control unit 15 to have the display unit 16 display this obtained file, whereby a Web page based on the file is displayed on the display unit 16 in step B2. In addition to the display of the Web page, the control unit 13 also stores an URL address of this obtained file into a predetermined storage area of the storage unit 14 in step B3. If any other URL address has already been stored in the predetermined storage area of the storage unit 14, then the other URL address may be deleted before the URL address of this obtained file is then stored in the predetermined storage area of the storage unit 14. If the above-described reference information has already been stored in the predetermined storage area of the storage unit 14, then the reference information may be deleted before the URL address of this obtained file is then stored in the predetermined storage area of the storage unit 14.

The operation of referring a file in the server 30 by the mobile communication terminal 10 placed in a stand-by mode in the mobile communication system will be described with reference to FIGS. 1, 4 and 5B. In step B4, the mobile communication terminal 10 is transitioned from the communication mode into the stand-by mode, whereby the display screen is transitioned to the stand-by screen. In step B5, the control unit 3 obtains the stored URL address from the storage unit 14. In step B6, the control unit 13 finds a corresponding icon to the URL address with reference to a table stored in the storage unit 14, wherein the table includes correspondences between the URL address and the file. The control unit 13 instructs the display control unit 15 to display the found icon, whereby the ion is displayed on the stand-by screen. The control unit 13 further links the displayed icon to the URL address designating the file, so that the control unit 13 stores this information of the link between the icon and the URL address into a predetermined storage area of the storage unit 14 in step B7.

In step B8, if the icon displayed on the stand-by screen is selected by user through the input unit 17, then the control unit 13 obtains the link information from the storage unit 14 in step B9. The control unit 13 obtains the file linked with the URL address from the server 30 through the base station 20 and the communication network 40 in step B10. The Web page of this file is again displayed on the display unit 16, thereby allowing user to refer the Web page of this file again in step B11.

These sequential operations of referring the Web-page in the stand-by mode are associated with the above-described operations shown in FIG. 2B, wherein the data are associated with Web-data, and the reference information is associated with the URL address.

The control unit 3 obtains the reference information and the stored URL address from the storage unit 14. The control unit 13 finds a first icon corresponding to the kind of data included in the obtained reference information and a second icon corresponding to the URL address. The control unit 13 instructs the display control unit 15 to display the found first and second icons, whereby the first and second icons are displayed on the stand-by screen. The control unit 13 further links the displayed first icon to the reference information designating the file, so that the control unit 13 stores this first link information of the link between the first icon and the reference information into a predetermined storage area of the storage unit 14. The control unit 13 further links the displayed icon to the URL address designating the file, so that the control unit 13 stores this second link information of the link between the icon and the URL address into a predetermined storage area of the storage unit 14. If the first icon displayed on the stand-by screen is selected by user through the input unit 17, then the control unit 13 obtains the first link information from the storage unit 14. The control unit 13 selects the data associated to the selected first icon, based on the obtained first link information and instructs the output interface to output the selected data, thereby allowing user to refer the data again. If the second icon displayed on the stand-by screen is selected by user through the input unit 17, then the control unit 13 obtains the second link information from the storage unit 14. The control unit 13 obtains the file linked with the URL address from the server 30 through the base station 20 and the communication network 40. The Web page of this file is again displayed on the display unit 16, thereby allowing user to refer the Web page of this file again.

As described above, the above-described novel mobile communication terminal 10 is configured to display at least one icon on the stand-by mode display screen, wherein the icon is linked to data which had been referred by user and stored in the mobile communication terminal 10, or the icon is linked to a file which had been referred by user and stored in the server 30. Selecting or designating the icon displayed on the stand-by mode display screen causes automatic display operation of displaying the data or the file again on the display unit 16 without repeating the sequential operations necessary for having obtained the data or the file at first time.

As described above, upon selecting the icon display on the standby mode screen of the display unit 16, the data linked to the selected icon are outputted through the output interface. It is also possible as a modification that upon selecting the icon display on the stand-by mode screen of the display unit 16, a list of a plurality of executable functions related to the data linked to the selected ion is displayed on the stand-by mode display screen of the display unit 16.

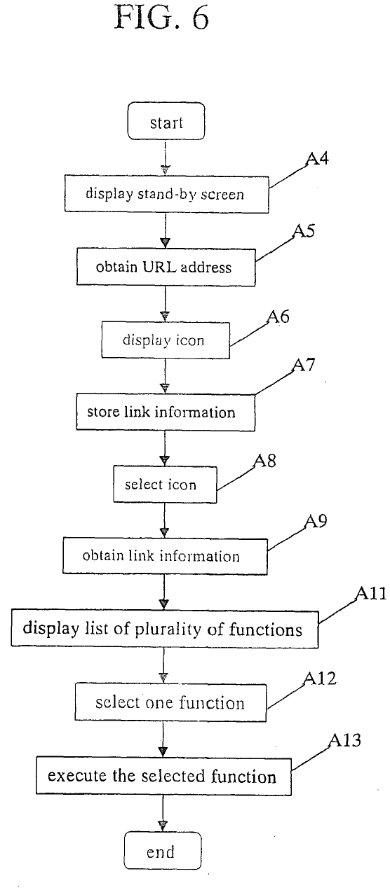

FIG. 6 is a flow chart illustrative of modified operations of referring data when the mobile communication terminal 10 shown in FIG. 1 is placed in a stand-by mode. These operations correspond to modifications to the above-described operations shown in FIG. 2B.

In step A4, the mobile communication terminal 10 is transitioned from the normal communication mode into the stand-by mode, whereby the display screen is transitioned to the stand-by screen or the stand-by picture. In step A5, the control unit 3 obtains the stored reference information from the storage unit 14. In step A6, the control unit 13 finds a corresponding icon to the kind of the data belonging to the obtained reference information with reference to a table stored in the storage unit 14, wherein the table includes correspondences between the reference informations and the kinds of data. The control unit 13 instructs the display control unit 15 to display the found icon, whereby the ion is displayed on the stand-by screen. The control unit 13 further links the displayed icon to the reference information designating the data, so that the control unit 13 stores this information of the link between the icon and the data or the reference information into a predetermined storage area of the storage unit 14 in step A7. In step A8, if the icon displayed on the stand-by screen is selected by user through the input unit 17, then the control unit 13 obtains the link information from the storage unit 14 in step A9. Step A11 follows to step A9.

In step A11, a list of a plurality of executable functions related to the data linked to the selected ion s displayed on the stand-by mode display screen of the display unit 16.

If the data linked to the selected icon are e-mail, then the plurality of executable functions listed may include a text display function of displaying the text of the e-mail, a reply function of replying e-mail to an e-mail sender, a transfer function of transferring e-mail, and a sender registration function of registering the e-mail sender in a predetermined area of the storage unit 14.

If the data linked to the selected icon are image data, then the plurality of executable functions listed may include an attachment function of attaching the image to the e-mail, and a wall paper setting function of setting a wall paper on the stand-by mode display screen.

If the data linked to the selected icon are sound data, then the plurality of executable functions listed may include an attachment function of attaching the sound to the e-mail, and a sound setting function of setting the sound as a call upon receipt of the e-mail.

If the data linked to the selected icon are telephone number data, then the plurality of executable functions listed may include a telephone function of dialing this telephone number and an e-mail preparing function of preparing an e-mail including this telephone number.

In step A12, user operates the input unit 17 to select one function from the list of the plurality of executable functions. In step A13, the selected function is started and executed. In case that the data are e-mail, user may select one function from the text display function, the reply function, the transfer function, and the sender registration function. If user selects the text display function in step A12, then the control unit 13 instructs the display control unit 15 to control the display unit 16 in displaying the text of the e-mail in step A13.

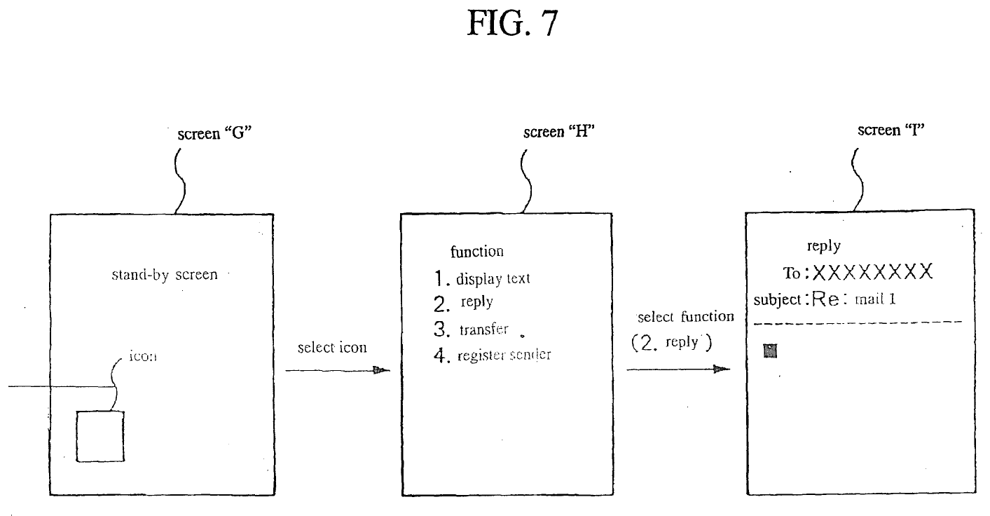

FIG. 7 is a view illustrative of one typical example of transition of the stand-by mode display screen of the display unit 16 over the sequential operations shown in FIG. 6. The following descriptions will be made by taking an example that the e-mail is referred.

With reference to FIGS. 1, 6 and 7, the icon is displayed on the stand-by mode display screen as shown by a screen “G”. This icon is selected by user, whereby the control unit 13 instructs the display control unit 1 to control the display unit 16 in displaying a list of a plurality of executable functions related to the data linked to the selected ion on the stand-by mode display screen as shown by a screen “H”. Normally, the current time information and the battery information are also displayed on the stand-by screen, even illustrations thereof are omitted in the screen “H”.

If an item “2” indicating the e-mail reply function is selected, then the e-mail reply function is started and executed, then the control unit 13 instructs the display control unit 15 to control the display unit 16 in displaying an e-mail preparing screen for enabling user to prepare a reply e-mail addressed to the e-mail sender as shown by a screen “I”.

In accordance with the operations shown in FIG. 6, after user completed to refer the data stored in the mobile communication terminal 10, then an icon is displayed on the stand-by screen, wherein the displayed icon is associated with the list of the plural executable functions related to the referred data.

The following modification to the operations shown in FIG. 5B may be available. In accordance with the operations shown in FIG. 5B, selection of the icon displayed on the display unit 16, the control unit 13 instructs the mobile communication terminal 10 to have an access to a file in the server 30 based on the linked URL address through the base station 20 and the communication network 40. It is also possible as a modification that a list of the plurality of executable functions related to the linked URL address is displayed on the stand-by mode display screen of the display unit 16.

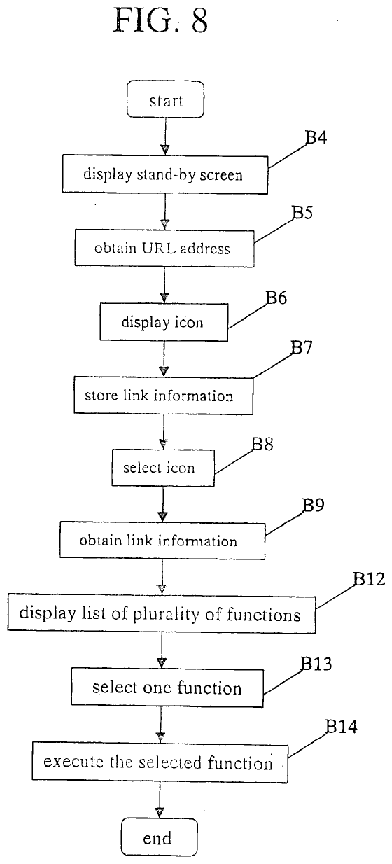

FIG. 8 is a flow chart illustrative of further modified operations of referring data when the mobile communication terminal 10 shown in FIG. 1 is placed in a stand-by mode. These operations correspond to further modifications to the above-described operations shown in FIG. 2B.

In step B4, the mobile communication terminal 10 is transitioned from the normal communication mode into the stand-by mode, whereby the display screen is transitioned to the stand-by screen or the stand-by picture. In step B5, the control unit 3 obtains the stored URL address from the storage unit 14. In step B6, the control unit 13 finds a corresponding icon to the kind of the file belonging to the obtained URL address with reference to a table stored in the storage unit 14, wherein the table includes correspondences between the URL address and the file. The control unit 13 instructs the display control unit 15 to display the found icon, whereby the ion is displayed on the stand-by screen. The control unit 13 further links the displayed icon to the URL address designating the file, so that the control unit 13 stores this information of the link between the icon and the URL address into a predetermined storage area of the storage unit 14 in step B7. In step B8, if the icon displayed on the stand-by screen is selected by user through the input unit 17, then the control unit 13 obtains the link information from the storage unit 14 in step B9. Step B12 follows to step B9.

In step B12, a list of a plurality of executable functions related to the URL address linked to the selected ion is displayed on the stand-by mode display screen of the display unit 16. The list of a plurality of executable functions includes a browser function for having an access to the target file in the server 30 based on the URL address through the communication network 40, a bookmark function for registration of the URL address for allowing easy access to the file designated by the URL address, and an e-mail preparing function for preparing an e-mail including the URL address.

In step B13, user operates the input unit 17 to select one function from the list of the plurality of executable functions. In step B14, the selected function is started and executed. If the browser function is selected in step B13, the control unit 13 instructs the mobile communication terminal 10 to have an access to a file in the server 30 based on the URL address through the communication network 40, so as to obtain the file, whereby a Web-page of the obtained file is displayed on the stand-by mode display screen of the display unit 16.

In accordance with the operations shown in FIG. 8, after the mobile communication terminal 10 had have an access to the file in the server 30 through the communication network 40, an icon is displayed on the stand-by mode display screen, wherein the icon provides a plurality of executable functions related to the address linked to the file.

In accordance with the present invention, any display marks including icon, other image symbols, other visual representations, characters and numerals may be available for allowing user to designate the display object to be displayed or referred again.

The above described operations shown in FIGS. 2A, 2B, 5A, 5B, 6A, 6B and 8 may be implemented by having the control unit such as a CPU execute a computer-readable program which may be stored in any available storage unit such as a ROM.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. A communication terminal accessible to a communication network, said communication terminal including:
a display unit; and
a control unit configured to control said display unit in displaying, in a stand-by mode, at least one of:
a first display mark which provides a reference information linked to past-referred data stored in said communication terminal;
a second display mark which provides at least one executable function related to said past-referred data;
a third display mark which provides an access-related information allowing said communication terminal to have an access to a past-referred file stored in a computer device connected to said communication network, and said access-related information being linked to said file; and
a fourth display mark which provides at least one executable function related to said past-referred file.

2. The communication terminal as claimed in claim 1, wherein said access-related information includes an address.

3. The communication terminal as claimed in claim 1, wherein said computer device comprises a server computer.

4. The communication terminal as claimed in claim 1, wherein said communication terminal comprises a mobile communication terminal.

5. The communication terminal as claimed in claim 1, wherein said control unit controls said display unit to display said past-referred data upon selection of said first display mark.

6. The communication terminal as claimed in claim 1, wherein said control unit controls said display unit to display a lest of said at least one executable function related to said past-referred data upon selection of said second display mark.

7. The communication terminal as claimed in claim 1, wherein said control unit controls said communication terminal to have a re-access to said past-referred file in said computer device upon selection of said third display mark.

8. The communication terminal as claimed in claim 1, wherein said control unit controls said display unit to display a lest of said at least one executable function related to said past-referred file upon selection of said fourth display mark.

9. The communication terminal as claimed in claim 1, wherein if further data of the same kind as said past-referred data are referred after said past-referred data have been referred, then said control unit controls said display unit in displaying an additional first display mark which provides an additional reference information linked to said further data, instead of said first display mark.

10. The communication terminal as claimed in claim 1, wherein if further data of a different kind from said past-referred data are referred after said past-referred data have been referred, then said control unit controls said display unit in displaying not only said first display mark which provides said reference information linked to said past-referred data, but also an additional first display mark which provides an additional reference information linked to said further data.

11. The communication terminal as claimed in claim 1, wherein if a further file to said past-referred file is referred after said past-referred file has been referred, then said control unit controls said display unit in displaying an additional third display mark which provides an additional access-related information allowing said communication terminal to have an access to said further file, instead of said file.

12. A method of controlling a communication terminal accessible to a communication network, said method including:
displaying, in a stand-by mode, at least one of:
a first display mark which provides a reference information linked to past-referred data stored in said communication terminal;
a second display mark which provides at least one executable function related to said past-referred data a third display mark which provides an access-related information allowing said communication terminal to have an access to a past-referred file stored in a computer device connected to said communication network, and said access-related information being linked to said file; and
a fourth display mark which provides at least one executable function related to said past-referred file.

13. The method as claimed in claim 12, wherein said access-related information includes an address.

14. The method as claimed in claim 12, wherein said computer device comprises a server computer.

15. The method as claimed in claim 12, wherein said communication terminal comprises a mobile communication terminal.

16. The method as claimed in claim 12, wherein said past-referred data are displayed upon selection of said first display mark.

17. The method as claimed in claim 12, wherein a lest of said at least one executable function related to said past-referred data is displayed upon selection of said second display mark.

18. The method as claimed in claim 12, wherein said communication terminal has a re-access to said past-referred file in said computer device upon selection of said third display mark.

19. The method as claimed in claim 12, wherein a lest of said at least one executable function related to said past-referred file is displayed upon selection of said fourth display mark.

20. The method as claimed in claim 12, wherein if further data of the same kind as said past-referred data are referred after said past-referred data have been referred, then an additional first display mark which provides an additional reference information linked to said further data is displayed, instead of said first display mark.

21. The method as claimed in claim 12, wherein if further data of a different kind from said past-referred data are referred after said past-referred data have been referred, then not only said first display mark which provides said reference information linked to said past-referred data, but also an additional first display mark which provides an additional reference information linked to said further data are displayed.

22. The method as claimed in claim 12, wherein if a further file to said past-referred file is referred after said past-referred file has been referred, then an additional third display mark which provides an additional access-related information allowing said communication terminal to have an access to said further file is displayed, instead of said file.

23. A program to be executed to implement a method of controlling a communication terminal accessible to a communication network, said program including:
displaying, in a stand-by mode, at least one of:
a first display mark which provides a reference information linked to past-referred data stored in said communication terminal a second display mark which provides at least one executable function related to said past-referred data a third display mark which provides an access-related information allowing said communication terminal to have an access to a past-referred file stored in a computer device connected to said communication network, and said access-related information being linked to said file; and
a fourth display mark which provides at least one executable function related to said past-referred file.

24. The program as claimed in claim 23, wherein said access-related information includes an address.

25. The program as claimed in claim 23, wherein said computer device comprises a server computer.

26. The program as claimed in claim 23, wherein said communication terminal comprises a mobile communication terminal.

27. The program as claimed in claim 23, wherein said past-referred data are displayed upon selection of said first display mark.

28. The program as claimed in claim 23, wherein a lest of said at least one executable function related to said past-referred data is displayed upon selection of said second display mark.

29. The program as claimed in claim 23, wherein said communication terminal has a re-access to said past-referred file in said computer device upon selection of said third display mark.

30. The program as claimed in claim 23, wherein a lest of said at least one executable function related to said past-referred file is displayed upon selection of said fourth display mark.

31. The program as claimed in claim 23, wherein if further data of the same kind as said past-referred data are referred after said past-referred data have been referred, then an additional first display mark which provides an additional reference information linked to said further data is displayed, instead of said first display mark.

32. The program as claimed in claim 23, wherein if further data of a different kind from said past-referred data are referred after said past-referred data have been referred, then not only said first display mark which provides said reference information linked to said past-referred data, but also an additional first display mark which provides an additional reference information linked to said further data are displayed.

33. The program as claimed in claim 23, wherein if a further file to said past-referred file is referred after said past-referred file has been referred, then an additional third display mark which provides an additional access-related information allowing said communication terminal to have an access to said further file is displayed, instead of said file.
